(19) United States
(12) Patent Application Publication
(10) Pub. No.: US 2026/0186149 A1
(43) Pub. Date: Jul. 2, 2026

(54) GNSS SIGNAL OUTPUT APPARATUS AND CONTROL METHOD FOR THE SAME

(71) Applicant: IDCITI.COM, Incheon (KR)

(72) Inventors: Jihoon RYOO, Incheon (KR); Hongjin LEE, Incheon (KR); In-sun KIM, Incheon (KR); Seonghoon PARK, Incheon (KR); Hamin LIM, Incheon (KR); Jisu RYU, Incheon (KR)

(21) Appl. No.: 19/434,568

(22) Filed: Dec. 29, 2025

(30) Foreign Application Priority Data
Dec. 31, 2024 (KR) 10-2024-0202356

(51) Int. Cl. G01S 19/23; G01S 19/11; G01S 19/24

(52) U.S. Cl. CPC G01S 19/23; G01S 19/11; G01S 19/24

(57) ABSTRACT

Proposed is a global navigation satellite system (GNSS) signal output apparatus. The GNSS signal output apparatus may include a reference receiver arranged within a GNSS shadow zone and configured to receive a reference satellite signal in a 360-degree range, and a plurality of repeater devices arranged within the GNSS shadow zone, configured to receive a directional satellite signal with a reception angle in an angular range of less than 360 degrees, and configured to radiate the received directional satellite signal. The plurality of repeater devices may be spaced apart from each other and may have different ranges of reception angles, and a sum of reception angles of the plurality of repeater devices may cover a range of 360 degrees, and each of the plurality of repeater devices may adjust a range of the reception angle based on the reference satellite signal received by the reference receiver.

### CROSS-REFERENCE TO RELATED APPLICATION

This application is based on and claims priority under 35 U.S.C. § 119 to Korean Patent Application No. 10-2024-0202356, filed on Dec. 31, 2024, in the Korean Intellectual Property Office, the disclosure of which is incorporated by reference herein in its entirety.

### BACKGROUND

### Technical Field

The disclosure relates to a global navigation satellite system (GNSS) signal output apparatus and a control method for the GNSS signal output apparatus.

### Description of Related Technology

A global navigation satellite system (GNSS) that recognizes a location by using a satellite signal is widely used to recognize a location of an object. The GNSS is technology for calculating location information of a receiver based on information received from a satellite. The GNSS includes, for example, a global positioning system (GPS) of the United States, GLONASS of Russia, a Galileo system of the European Union (EU), Beidou of China, Quasi-Zenith Satellite System (QZSS) of Japan, Indian Regional Navigation Satellite System of India, or the like.

### SUMMARY

One aspect is a global navigation satellite system (GNSS) in which a client device may receive a GNSS signal, in which its own location is reflected, in a GNSS shadow area, and a control method for a GNSS signal output apparatus.

Additional aspects will be set forth in part in the description which follows and, in part, will be apparent from the description, or may be learned by practice of the presented embodiments of the disclosure.

Another aspect is a global navigation satellite system (GNSS) signal output apparatus. The GNSS signal output apparatus may include a reference receiver arranged within a GNSS shadow zone and configured to receive a reference satellite signal in a 360-degree range, and a plurality of repeater devices arranged within the GNSS shadow zone, configured to receive a directional satellite signal with a reception angle in an angular range of less than 360 degrees, and configured to radiate the received directional satellite signal. The plurality of repeater devices may be spaced apart from each other and may have different ranges of reception angles, and a sum of reception angles of the plurality of repeater devices may cover a range of 360 degrees, and each of the plurality of repeater devices may adjust a range of the reception angle based on the reference satellite signal received by the reference receiver.

In addition, according to an embodiment, a designated reception angle range may be set within a 360-degree angle range for each of the plurality of repeater devices. Each of the plurality of repeater devices may adjust the reception angle of a respective repeater device so that a satellite signal in the designated reception angle range of the respective repeater device in the reference satellite signal and a directional satellite signal received by the respective repeater device are matched.

In addition, according to an embodiment, the plurality of repeater devices may be radially arranged around the reference receiver, and each of the plurality of repeater devices may have a reception angle corresponding to a direction in which a respective repeater device is arranged with respect to the reference receiver.

In addition, according to an embodiment, the plurality of repeater devices may include four repeater devices, and each of the plurality of repeater devices may have a reception angle of 90 degrees.

In addition, according to an embodiment, each of the plurality of repeater devices may include a directional antenna configured to receive a satellite signal with a limited reception angle, and an antenna driver configured to change the reception angle of the directional antenna. The antenna driver may be further configured to control the directional antenna to receive the satellite signal with the reception angle set in a respective repeater device.

In addition, according to an embodiment, the reference receiver and the plurality of repeater devices may operate by receiving power via an Ethernet cable in a Power of Ethernet (PoE) manner.

In addition, according to an embodiment, the reference receiver may correspond to a base station of Real-Time Kinematic (RTK) and may be configured to calculate an error of the received satellite signal. The reference receiver may be configured to transmit the calculated error of the satellite signal to each of the plurality of repeater devices, and the plurality of repeater devices may be configured to correct the directional satellite signal based on the received error of the satellite signal and then radiate the directional satellite signal.

In addition, according to an embodiment, a plurality of directional satellite signals radiated respectively from the plurality of repeater devices may be received by a client device within the GNSS shadow zone, and the client device may obtain a satellite signal by reconstructing the plurality of directional satellite signals.

In addition, according to an embodiment, the GNSS shadow zone may correspond to a lower portion of an overpass, and the reference receiver and the plurality of repeater devices may be installed in a structure in the lower portion of the overpass.

In addition, according to an embodiment, each of the plurality of repeater devices may include a directional output module configured to radiate the directional satellite signal to a target area within the GNSS shadow zone.

In addition, according to an embodiment, the plurality of repeater devices may be arranged in a radial shape around the reference receiver, and the target area may be an area including a center of the radial shape.

Another aspect is a control method for a global navigation satellite system (GNSS) signal output apparatus. The GNSS signal output apparatus may include a reference receiver arranged within a GNSS shadow zone, and a plurality of repeater devices arranged within the GNSS shadow zone. The plurality of repeater devices may be spaced apart from each other and may have different ranges of reception angles, and a sum of reception angles of the plurality of repeater devices may cover a range of 360 degrees. The control method for the GNSS signal output apparatus may include receiving, by the reference receiver, a reference satellite signal in a 360-degree range, receiving, by each of the plurality of repeater devices, a directional satellite signal with a reception angle of an angular range less than 360 degrees, adjusting, by each of the plurality of repeater devices, a range of the reception angle based on the reference satellite signal received by the reference receiver, and radiating, by each of the plurality of repeater devices, the received directional satellite signal.

### BRIEF DESCRIPTION OF THE DRAWINGS

The above and other aspects, features, and advantages of certain embodiments of the disclosure will be more apparent from the following description taken in conjunction with the accompanying drawings.

The disclosure may be easily understood from the following detailed description and a combination of drawings involved therein, and reference numerals refer to structural elements.

FIG. 1 is a diagram illustrating an installation of a global navigation satellite system (GNSS) signal output apparatus according to an embodiment.

FIG. 2 is a block diagram illustrating a structure of a GNSS signal output apparatus according to an embodiment.

FIG. 3 is a flowchart of a control method for a GNSS signal output apparatus, according to an embodiment.

FIG. 4 is a diagram illustrating a disposition of a reference receiver and a plurality of repeater devices according to an embodiment.

FIG. 5 is a diagram illustrating a structure of a reference receiver and a plurality of repeater devices according to an embodiment.

FIG. 6 is a diagram illustrating a reference satellite signal and a directional satellite signal according to an embodiment.

FIG. 7 is a diagram illustrating a process by which a client device obtains a satellite signal, according to an embodiment.

FIG. 8 is a flowchart of an operation in which a reference receiver serves as a real-time kinetic (RTK) base station, according to an embodiment.

### DETAILED DESCRIPTION

Because the GNSS utilizes information received from a satellite, there is a limitation in that it is difficult to identify the location of the receiver in a GNSS shadow area in which a line of sight (LOS) with the satellite has an obstacle, such as underground facilities. Due to this, when location information is provided indoors by using the GNSS, it is difficult to provide accurate location information. For example, in systems that involve provision of location information indoors, underground, or inside a tunnel, such as a bus arrival time notification service below an overpass and a navigation guide system within an underground facility, the quality of public services that are useful to citizens may deteriorate due to the limitations of the GNSS. In addition, a user is unable to receive GNSS signals in the GNSS shadow area, and thus, location information may not be obtained, which is inconvenient.

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

The present specification clarifies the scope of the claims of the disclosure, and describes the principles of embodiments and discloses the embodiments so that a person having ordinary skill in the art to which the embodiments belong can practice the embodiments. The disclosed embodiments may be implemented in various forms.

It should be understood that the various embodiments and terms used in the present document are not intended to limit the technical features described in the present document to specific embodiments, but rather to include various modifications, equivalents, or substitutes of the embodiments.

In connection with the description of the drawings, similar reference numerals may be used for similar or related components.

The singular form of a noun corresponding to an item may include one or more of said items, unless the relevant context clearly indicates otherwise.

Terms such as “first” or “second” may be used simply to distinguish one component from another component and do not qualify the components in any other respect (e.g., importance or order).

When a component (e.g., a first component) is referred to as being “coupled” or “connected” to another component (e.g., a second component), with or without the terms “functionally” or “communicatively”, it means that the component can be connected to the other component directly (e.g., wired), wirelessly, or through a third component.

The terms “include” or “have” are intended to specify the presence of a feature, number, step, operation, component, part or combination thereof described in the present document, but do not preclude the presence or addition of one or more other features, numbers, steps, operations, components, parts or combinations thereof.

When a component is said to be “connected”, “coupled”, “supported”, or “in contact with” another component, this includes not only cases where the components are directly connected, coupled, supported, or in contact, but also cases where the components are indirectly connected, coupled, supported, or in contact through a third component.

Throughout the specification, identical reference numerals refer to identical components. The present specification does not describe all elements of embodiments, and omit contents that are general in the technical field to which embodiments belong or that overlap between the embodiments. The term “part” (portion) used in the specification may be implemented as software or hardware, and depending on the embodiments, a plurality of “parts” may be implemented as one unit (element), or one “part” may include a plurality of elements. Hereinafter, embodiments and operating principles of the embodiments are described with reference to the accompanying drawings.

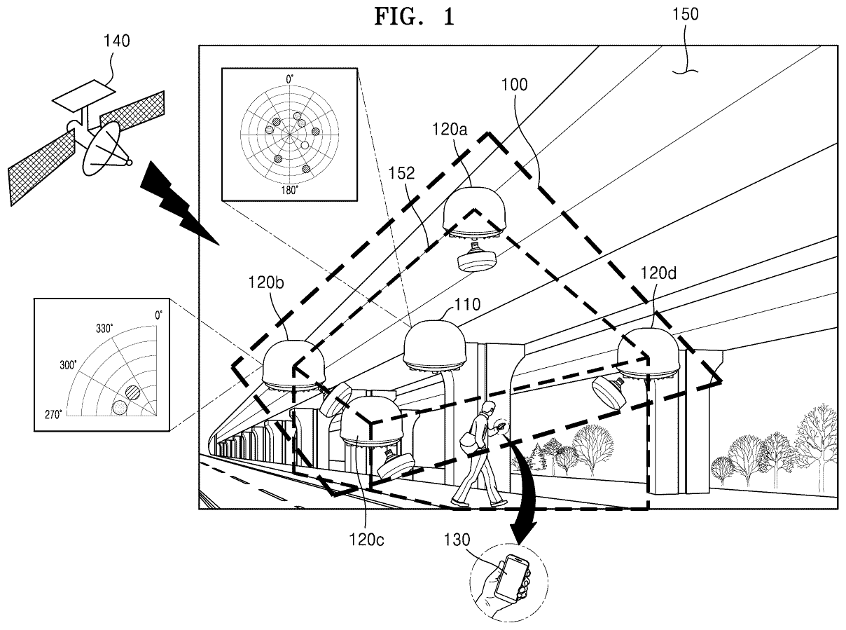

FIG. 1 is a diagram illustrating an installation of a global navigation satellite system (GNSS) signal output apparatus according to an embodiment.

The GNSS signal output apparatus 100 according to an embodiment may output a satellite signal of a GNSS in a GNSS shadow zone 152. The GNSS shadow zone 152 may also be referred to as a GNSS denied area. The GNSS shadow zone 152 is a space where satellite signals are not transmitted due to obstacles such as concrete and steel bars. The GNSS shadow zone 152 may correspond to an area under an overpass, a covered road, a covered park, a temporary building, the interior of a building, a tunnel, an underground parking lot, or an underground space. In the disclosure, an example is described in which the GNSS shadow zone 152 is located below an overpass 150. However, embodiments are not limited to cases where the GNSS shadow zone 152 is under the overpass 150, and the GNSS signal output apparatus 100 according to an embodiment may be arranged in various GNSS shadow zones 152.

The GNSS signal output apparatus 100 may include a reference receiver 110 and a plurality of repeater devices 120a, 120b, 120c, and 120d. The reference receiver 110 and the plurality of repeater devices 120a, 120b, 120c, and 120d may be installed in various structures within the GNSS shadow zone 152. For example, the reference receiver 110 and the plurality of repeater devices 120a, 120b, 120c, and 120d may be installed on a ceiling of a lower portion of the overpass 150 or on a pillar of the overpass 150. The number of the plurality of repeater devices 120a, 120b, 120c, and 120d may be set differently depending on the embodiment.

The reference receiver 110 may receive a real-time satellite signal from a satellite 140. The reference receiver 110 may receive the satellite signal at a reception angle of 360 degrees. That is, the reference receiver 110 may receive the satellite signal from all directions without any restrictions on the reception angle. The real-time satellite signal in the 360-degree range received by the reference receiver 110 is referred to as a reference satellite signal.

The plurality of repeater devices 120a, 120b, 120c, and 120d may receive the real-time satellite signal over a limited range of reception angles, less than 360 degrees. A satellite signal with a limited range of reception angles received by the plurality of repeater devices 120a, 120b, 120c, and 120d is referred to as a directional satellite signal. A direction and size of the reception angle may be set differently depending on the embodiment. According to an embodiment, magnitudes of the reception angles of the plurality of repeater devices 120a, 120b, 120c, and 120d are all the same, and directions of the reception angles may be set differently.

The reception angles of the plurality of repeater devices 120a, 120b, 120c, and 120d may be set to cover 360 degrees by adding up the reception angles of the plurality of repeater devices 120a, 120b, 120c, and 120d. According to an embodiment, when the reception angles of the plurality of repeater devices 120a, 120b, 120c, and 120d are added together, the angle ranges may correspond to 360 degrees without overlapping. In addition, according to an embodiment, the reception angles of the plurality of repeater devices 120a, 120b, 120c, and 120d may be combined to overlap each other while covering 360 degrees.

In addition, according to an embodiment, the reception angles of the plurality of repeater devices 120a, 120b, 120c, and 120d may be set to correspond to the direction in which the plurality of repeater devices 120a, 120b, 120c, and 120d are installed within the GNSS shadow zone 152. For example, when the first repeater device 120a is arranged in the first quadrant direction with the reference receiver 110 as the center, the first repeater device 120a may have a reception angle corresponding to the first quadrant with the reference receiver 110 as the center. In the disclosure, the plurality of repeater devices 120a, 120b, 120c, and 120d correspond to four repeater devices 120a, 120b, 120c, and 120d, and each of the repeater devices 120a, 120b, 120c, and 120d has a reception angle range of 90 degrees. However, this is an embodiment, and the number of the plurality of repeater devices 120a, 120b, 120c, and 120d and the range of the reception angle of the plurality of repeater devices may be determined variously depending on the embodiment. The range of the reception angles may be set to, for example, 30 degrees, 60 degrees, 90 degrees, 120 degrees, or 180 degrees. When 12 repeater devices are arranged in one reference receiver 110, the reception angle can be set to 30 degrees. When six repeater devices are arranged in one reference receiver 110, the reception angle may be set to 60 degrees.

Each of the plurality of repeater devices 120a, 120b, 120c, and 120d may adjust the range of its reception angle based on the reference satellite signal received from the reference receiver 110. Each of the plurality of repeater devices 120a, 120b, 120c, and 120d may have a preset reception angle range. For example, the first repeater device 120a may have a reception angle range corresponding to the first quadrant, the second repeater device 120b may have a reception angle range corresponding to the second quadrant, the third repeater device 120c may have a reception angle range corresponding to the third quadrant, and the fourth repeater device 120d may have a reception angle range corresponding to the fourth quadrant. Each repeater device 120a, 120b, 120c, or 120d may determine, based on the reference satellite signal, whether the reception angle range of the directional satellite signal it receives corresponds to a preset reception angle range, and adjust its own reception angle range.

In addition, each repeater device 120a, 120b, 120c, or 120d may output the received directional satellite signal. The repeater devices 120a, 120b, 120c, and 120d may radiate the directional satellite signal into the GNSS shadow zone 152. According to an embodiment, the repeater devices 120a, 120b, 120c, and 120d may output the directional satellite signal with a limited radiation angle by using a directional output module.

The directional satellite signal output from the repeater devices 120a, 120b, 120c, and 120d may be received by a client device 130 below the overpass 150. The client device 130 may be an electronic device used by a person or vehicle passing under the overpass 150. The client device 130 may correspond to, for example, a mobile phone, a wearable device, a tablet personal computer (PC), a laptop PC, or a vehicle electrical system. The client device 130 is an electronic device including a GNSS module, which can receive GNSS satellite signals and obtain location information from the satellite signals. According to an embodiment, the client device 130 may receive a directional satellite signal from the plurality of repeater devices 120a, 120b, 120c, and 120d, and obtain location information from the directional satellite signal in an existing GNSS module. According to an embodiment, a plurality of directional satellite signals have different delay times depending on the actual location of the client device 130. Therefore, the directional satellite signal received by the client device 130 has a delay time that reflects the location of the client device 130 within the GNSS shadow zone 152. By reflecting the delay time in the directional satellite signal, the client device 130 may receive satellite signals that reflect even changes in location within the GNSS shadow zone 152, thereby obtaining more accurate location information.

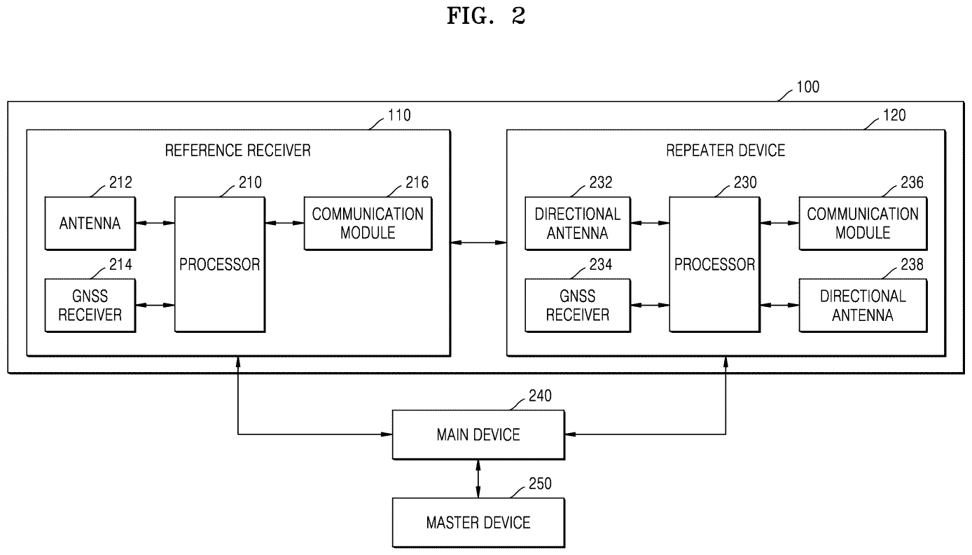

FIG. 2 is a block diagram illustrating a structure of the GNSS signal output apparatus according to an embodiment.

According to an embodiment, the GNSS signal output apparatus 100 may include the reference receiver 110 and a repeater device 120. In the disclosure, the plurality of repeater devices 120a, 120b, 120c, and 120d are collectively referred to as identification number 120. The GNSS signal output apparatus 100 may include the reference receiver 110 and the plurality of repeater devices 120.

The reference receiver 110 and the repeater device 120 may be spaced apart from each other. The reference receiver 110 and the repeater device 120 may be connected via a certain wired or wireless communication network. According to an embodiment, the reference receiver 110 and the repeater device 120 may communicate by using Ethernet or the like. Each repeater device 120 may be connected to the reference receiver 110 through Ethernet or the like. According to an embodiment, a distance between each repeater device 120 and the reference receiver 110 may be set to a distance within about 100 m. According to an embodiment, each repeater device 120 may be connected to the reference receiver 110 at a distance of up to 40 km by using optical communication using an optical cable.

The reference receiver 110 may include an antenna 212, a GNSS receiver 214, a processor 210, and a communication module 216.

Antenna 212 can receive GNSS signals transmitted from satellites. The antenna 212 may support multiple GNSS bands (e.g. GPS L1/L2, Galileo E1/E5, GLONASS L1, etc.). The antenna 212 may include a low noise amplifier (LNA) to improve signal sensitivity.

The antenna 212 of the reference receiver 110 is an antenna that receives electromagnetic wave signals in all 360 degrees. The antenna 212 may correspond to an omnidirectional antenna. The antenna 212 may provide performance close to isotropic characteristics, which means the antenna may radiate or receive signals in all directions.

According to an embodiment, the antenna 212 may be arranged outside the GNSS shadow zone. The antenna 212 may be connected to the reference receiver 110 via a wire or wirelessly and may be arranged in a location where there are no obstructions to satellite signals.

The GNSS receiver 214 may convert an analog signal received from antenna 212 into a digital signal, decode a GNSS signal, and synchronize them. The GNSS receiver 214 may transmit the decoded GNSS signal to the processor 210.

The GNSS receiver 214 may downconvert a frequency of the GNSS signal by using an RF front end. In addition, the GNSS receiver 214 may perform bandpass filtering through the RF front end to optimize a signal-to-noise ratio (SNR). The GNSS receiver 214 may synchronize a satellite signal based on Pseudo Random Noise (PRN) codes and track a carrier frequency and phase information of the signal by using a signal tracking module. The GNSS receiver 214 may track multiple satellite signals simultaneously. The GNSS receiver 214 may transmit, to the processor 210, basic data for calculating high-precision location data.

The processor 210 may control the overall operations of the reference receiver 110. The processor 210 may be implemented with one or more processors. The processor 210 may execute an instruction or command stored in a memory (not shown) to perform a certain operation. In addition, the processor 210 may control operations of components provided in the reference receiver 110. The processor 210 may include a micro controller unit (MCU), a central processing unit (CPU), a microprocessor, a graphics processing unit (GPU), or a neural processing unit (NPU).

The processor 210 may process data transmitted from the GNSS receiver 214 to generate satellite reception angle information for each satellite. The processor 210 may identify a current reception angle corresponding to each satellite and generate satellite reception angle information. According to an embodiment, the processor 210 may individually generate satellite reception angle information corresponding to a reception angle range set for each of the plurality of repeater devices 120. For example, the processor 210 may generate satellite reception angle information of the first quadrant (0 to 90 degrees phase) corresponding to the first repeater device 120a, satellite reception angle information of the second quadrant (90 to 180 degrees phase) corresponding to the second repeater device 120b, satellite reception angle information of the third quadrant (180 to 270 degrees phase) corresponding to the third repeater device 120c, and satellite reception angle information of the fourth quadrant (270 to 360 degrees phase) corresponding to the fourth repeater device 120d.

The communication module 216 may communicate with the plurality of repeater devices 120. The communication module 216 may communicate with the plurality of repeater devices 120 via wired or wireless communication. According to an embodiment, the communication module 216 may communicate with a plurality of repeater devices via Ethernet. In addition, according to an embodiment, the reference receiver 110 may be receive Power over Ethernet (PoE) via Ethernet and operate as a power source using PoE.

According to an embodiment, the communication module 216 may communicate with an external device. For example, the communication module 216 may communicate with a main device 240. Additionally, according to an embodiment, the communication module 216 may communicate with a master device 250.

The repeater device 120 may include a processor 230, a directional antenna 232, a GNSS receiver 234, a communication module 236, and a directional output module 238.

The directional antenna 232 is an antenna that receives satellite signals within a set reception angle range. The directional antenna 232 may provide high gain within the set reception angle range and minimize signal interference in directions outside the reception angle range. The reception angle range may be defined as, for example, 0 to 90 degrees, 90 to 180 degrees, 180 to 270 degrees, or 170 to 360 degrees. The reception angle range may be defined on a reference plane parallel to a horizontal plane. For example, a certain reference plane may be divided into four quadrants, and the reception angle range of the first repeater device 120a may be defined as the first quadrant, the reception angle range of the second repeater device 120b may be defined as the second quadrant, the reception angle range of the third repeater device 120c may be defined as the third quadrant, and the reception angle range of the fourth repeater device 120d may be defined as the fourth quadrant.

The directional antenna 232 may be configured to have an adjustable reception angle range. The directional antenna 232 may include a radiator and a reflector for receiving a satellite signal. The radiator may absorb electromagnetic waves in a frequency band corresponding to the satellite signal and convert the absorbed electromagnetic waves into electrical signals. The reflector may be located at the rear of the radiator to block unwanted signals coming from the rear and focus satellite signals coming from the front onto the radiator. The directional antenna 232 may adjust the reception angle range by adjusting a direction of a signal receiving surface of the radiator and reflector. The directional antenna 232 may include an antenna drive module that adjusts the reception angle range by rotating the radiator and reflector around a certain central axis.

According to an embodiment, the directional antenna 232 may be arranged outside the GNSS shadow zone. The directional antenna 232 may be connected to the repeater device 120 via a wire or wirelessly and may be arranged in a location where there are no obstructions to satellite signals.

The GNSS receiver 234 may convert an analog signal received from directional antenna 232 into a digital signal, decode a GNSS signal, and synchronize them. The GNSS receiver 234 may transmit the decoded GNSS signal to the processor 230.

The GNSS receiver 234 may downconvert a frequency of the GNSS signal by using an RF front end. In addition, the GNSS receiver 234 may perform bandpass filtering through the RF front end to optimize an SNR. The GNSS receiver 234 may synchronize satellite signals based on PRN codes and track a carrier frequency and phase information of the signals by using a signal tracking module. The GNSS receiver 234 may track multiple satellite signals simultaneously. The GNSS receiver 234 may transmit, to the processor 230, basic data for calculating high-precision location data.

The processor 230 may control the overall operations of the repeater device 120. The processor 230 may be implemented with one or more processors. The processor 230 may execute an instruction or command stored in a memory (not shown) to perform a certain operation. In addition, the processor 230 may control operations of components provided in the repeater device 120. The processor 230 may include an MCU, a CPU, a microprocessor, a GPU, or an NPU.

The processor 230 may process data transmitted from the GNSS receiver 234 to generate satellite reception angle information for each satellite. The processor 230 may identify a current reception angle corresponding to each satellite and generate satellite reception angle information. According to an embodiment, the processor 230 may determine whether a reception angle range of a directional satellite signal received at the repeater device 120 corresponds to a set reception angle range, based on the reference satellite signal received at the reference receiver 110. The processor 230 may compare satellite reception angle information of the satellite signal corresponding to the reception angle range set in the reference satellite signal with satellite reception angle information of the received directional satellite signal to determine whether the current reception angle range of the repeater device 120 is appropriate. The processor 230 may adjust the reception angle range by driving the directional antenna 232, based on the determination as to whether the reception angle range is appropriate.

The communication module 236 may communicate with the reference receiver 110. The communication module 236 may communicate with the reference receiver 110 via wired or wireless communication. According to an embodiment, the communication module 236 may communicate with the reference receiver 110 via Ethernet. In addition, according to an embodiment, the repeater device 120 may receive PoE via Ethernet and operate as a power source using PoE.

According to an embodiment, the communication module 236 may communicate with an external device. For example, the communication module 236 may communicate with the main device 240. Additionally, according to an embodiment, the communication module 236 may communicate with the master device 250.

The directional output module 238 may receive satellite signals, amplify them, and retransmit them. The directional output module 238 may amplify a directional satellite signal received from the directional antenna 232. In addition, the directional output module 238 may remove noise and interference signals from the satellite signal. In addition, the directional output module 238 may output the amplified and signal-processed satellite signal. The directional output module 238 may output the directional satellite signal within a set radiation angle range. The set radiation angle range may be an angular range directed toward a target area within the GNSS shadow zone. The radiation angle range may be defined in terms of the reference plane for the reception angle range. According to an embodiment, the radiation angle range of each repeater device 120 may be an angular range that is 180 degrees different from the reception angle range. For example, when the reception angle range of the repeater device 120 is set to 180 to 270 degrees, the radiation angle range may correspond to 0 to 90 degrees.

The directional output module 238 may include a directional output antenna that outputs directional satellite signals. The directional antenna 232, which receives satellite signals, and the directional output antenna of the directional output module 238 may be provided separately from each other.

The main device 240 may correspond to a network hub, a wired/wireless router, or router. The main device 240 may include a plurality of PoE switches. The reference receiver 110 may be connected to one of the plurality of PoE switches of the main device 240 and may be connected to Ethernet through the main device 240. In addition, the reference receiver 110 may receive power via PoE from the main device 240. In addition, according to an embodiment, each repeater device 120 may be connected to one of the plurality of PoE switches of the main device 240 and may be connected to Ethernet through the main device 240. In addition, according to an embodiment, each repeater device 120 may receive power via PoE from the main device 240.

In addition, the main device 240 may serve as a Wi-Fi access point (AP). The main device 240 may perform Wi-Fi communication with external devices. In addition, the main device 240 may relay communications between the reference receiver 110 and the plurality of repeater devices 120 and external devices that perform Wi-Fi communication.

The master device 250 may correspond to a device used by an administrator of the GNSS signal output apparatus 100. The master device 250 may correspond to, for example, a mobile phone, a tablet PC, a laptop PC, or a desktop PC. The master device 250 may communicate with at least one of the reference receiver 110 or the plurality of repeater devices 120 via the main device 240. The master device 250 may communicate with the main device 240 via wired or wireless communication. For example, the master device 250 may communicate with the main device 240 via Wi-Fi communication, Bluetooth communication, or Ethernet.

According to an embodiment, the master device 250 may monitor the reference receiver 110 or the plurality of repeater devices 120. The master device 250 may monitor an operating status, satellite signal reception information, or reception angle range of the reference receiver 110 or the plurality of repeater devices 120. In addition, according to an embodiment, the master device 250 may control the reference receiver 110 or the repeater device 120, or set a certain mode or parameter. According to an embodiment, the master device 250 may set or change the reception angle range or radiation angle range of the repeater device 120.

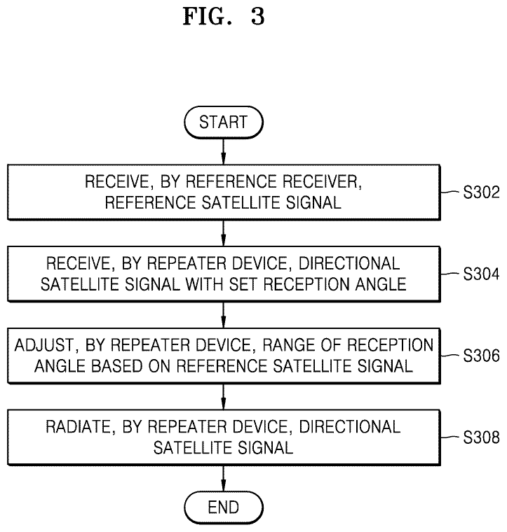

FIG. 3 is a flowchart of a control method for a GNSS signal output apparatus, according to an embodiment.

The control method for a GNSS signal output apparatus, according to an embodiment, may be performed by the GNSS signal output apparatus 100 according to an embodiment. However, the control method for the GNSS signal output apparatus, according to an embodiment, is not limited to an embodiment performed by the GNSS signal output apparatus 100 according to an embodiment, and may be performed by various systems including a GNSS receiving device and a repeater device.

Referring to FIG. 3, in operation S302, the GNSS signal output apparatus 100 may receive a reference satellite signal. The reference receiver 110 of the GNSS signal output apparatus 100 may receive the reference satellite signal in an omnidirectional 360-degree range. The reference satellite signal is a real-time satellite signal.

In addition, in operation S304, the GNSS signal output apparatus 100 may receive a directional satellite signal by using the plurality of repeater devices 120. The plurality of repeater devices 120 may receive satellite signals over a limited range of reception angles. The plurality of repeater devices 120 may have different reception angle ranges. In addition, by adding up the reception angle ranges of the plurality of repeater devices 120, a 360-degree range may be covered.

Operations S302 and S304 may be performed in parallel.

Next, in operation S306, the GNSS signal output apparatus 100 may adjust the reception angle range of the plurality of repeater devices 120 based on the reference satellite signal. Each of the repeater devices 120 may have a set reception angle range. For example, the GNSS signal output apparatus 100 may include four repeater devices 120, and the repeater devices 120 may have reception angle ranges corresponding to the first quadrant, the second quadrant, the third quadrant, and the fourth quadrant, respectively. The GNSS signal output apparatus 100 may compare a satellite signal corresponding to the reception angle range of each repeater device 120 in the reference satellite signal with a directional satellite signal received from each repeater device 120, and adjust the reception angle range of each repeater device 120 based on the result of the comparison. Each repeater device 120 may adjust the reception angle range by comparing the received directional satellite signal with the reference satellite signal and controlling a signal reception direction of the directional antenna 232.

Next, in operation S308, the GNSS signal output apparatus 100 may radiate the directional satellite signal through the repeater device 120. The GNSS signal output apparatus 100 may radiate the directional satellite signal to a target area within a GNSS shadow zone. Each repeater device 120 may set a radiation angle of the directional output module 238 to radiate the directional satellite signal to the target area. The directional satellite signal output from the plurality of repeater devices 120 may be received by the client device 130 within the target area. The client device 130 may obtain location information by using the directional satellite signal received from the plurality of repeater devices 120.

The GNSS signal output apparatus 100 may perform the operation of adjusting the reception angle range in operation S306 while performing the operation of radiating the directional satellite signal in operation S308. In addition, the GNSS signal output apparatus 100 may perform operations S302, S304, S306, and S308 in parallel, and the order of each operation is not limited to the order shown in FIG. 3.

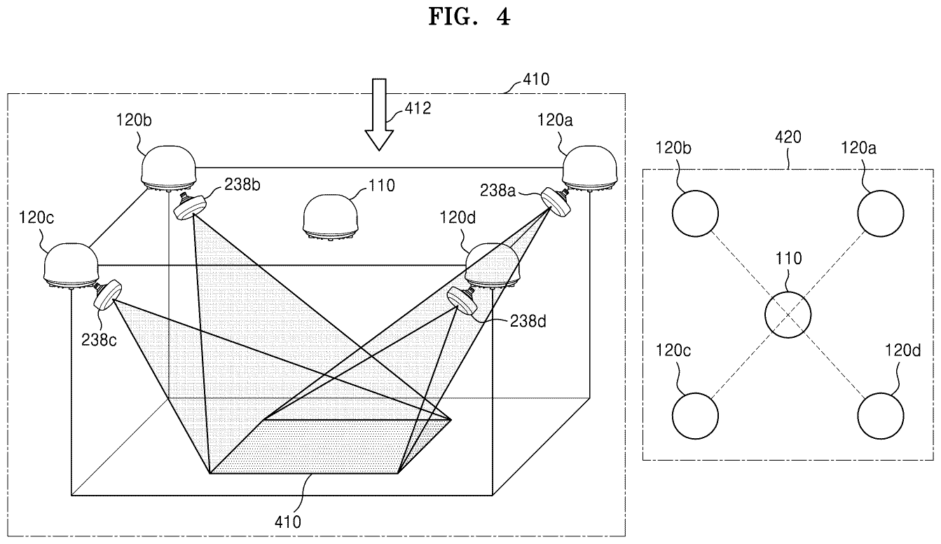

FIG. 4 is a diagram illustrating a disposition of a reference receiver and a plurality of repeater devices according to an embodiment.

Identification number 410 is a perspective view showing an arrangement of the reference receiver 110 and the plurality of repeater devices 120a, 120b, 120c, and 120d. Identification number 420 is a drawing showing the reference receiver 110 and the plurality of repeater devices 120a, 120b, 120c, and 120d as viewed from a first direction 412, which is a top-down view.

According to an embodiment, the reference receiver 110 may be disposed in the center, and the plurality of repeater devices 120a, 120b, 120c, and 120d may be disposed around the reference receiver 110. The plurality of repeater devices 120a, 120b, 120c, and 120d may be radially arranged around the reference receiver 110. A distance between the reference receiver 110 and the plurality of repeater devices 120a, 120b, 120c, and 120d may be set to be the same. An angle between the plurality of repeater devices 120a, 120b, 120c, and 120d centered around the reference receiver 110 may be 90 degrees.

The repeater devices 120a, 120b, 120c, and 120d may include directional output modules 238a, 238b, 238c, and 238d, respectively. The directional output modules 238a, 238b, 238c, and 238d may be arranged to output a directional satellite signal to a target area 440 within a GNSS shadow zone 430.

In FIG. 4, the reference receiver 110 is arranged at the center of an upper surface of a rectangular solid, and the plurality of repeater devices 120a, 120b, 120c, and 120d are arranged at the vertices of the upper surface of a cube, and distances from the reference receiver 110 to each of the repeater devices 120a, 120b, 120c, and 120d are equally arranged. However, depending on the actual implementation, the arrangement of the reference receiver 110 and the plurality of repeater devices 120a, 120b, 120c, and 120d may be adjusted. For example, depending on the structure of a lower portion of an overpass, the arrangement of the reference receiver 110 and the plurality of repeater devices 120a, 120b, 120c, and 120d may differ from that of the embodiment of FIG. 4. The reference receiver 110 and the plurality of repeater devices 120a, 120b, 120c, and 120d may be out of the same plane depending on the structure of the lower portion of the overpass, and the distance between the reference receiver 110 and each of the repeater devices 120a, 120b, 120c, and 120d may not be equal but may be adjusted to be substantially equal.

According to an embodiment, because the repeater devices 120a, 120b, 120c, and 120d are spaced apart from each other, when the client device 130 receives a directional satellite signal in the target area 440, delay times of the directional satellite signals output from the repeater devices 120a, 120b, 120c, and 120d are different from each other. Therefore, according to an embodiment, the accuracy of location information calculated from the client device 130 may be maintained even when the locations of the plurality of repeater devices 120a, 120b, 120c, and 120d deviate from the vertices of the rectangular solid.

The target area 440 may correspond to a certain area including the ground within the GNSS shadow zone. The target area 440 may be an area that includes a point where the reference receiver 110 is projected onto the ground. In addition, the target area 440 may be an area that includes the centers of the plurality of repeater devices 120 projected onto the ground.

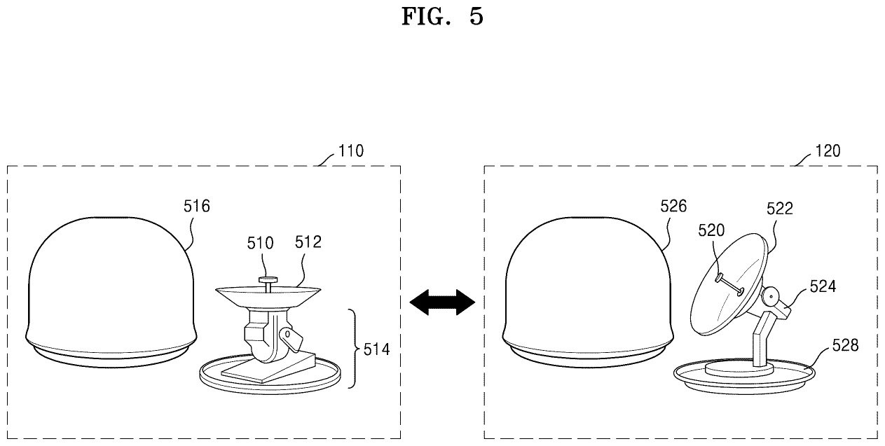

FIG. 5 is a diagram illustrating a structure of a reference receiver and a plurality of repeater devices according to an embodiment.

According to an embodiment, the reference receiver 110 may include a radiator 510, a reflector 512, a support member 514, and a cover 516.

The radiator 510 may absorb a satellite signal and convert the absorbed satellite signal into an electrical signal. The reflector 512 may block unwanted signals coming from the rear of the radiator. In addition, the reflector 512 may focus an incoming satellite signal onto the radiator 510. The signal reception performance may be improved by the reflector 512.

The support member 514 may fix and support the radiator 510 and the reflector 512. The support member 514 may include a certain driving circuit in an internal space thereof. The driving circuit may include the processor 210, the GNSS receiver 214, the communication module 216, and a power module (not shown).

The cover 516 may cover the reference receiver 110 and protect components of the reference receiver 110. The cover 516 may correspond to, for example, a radome. The cover 516 may have a property of transmitting a satellite signal.

The repeater device 120 may include a radiator 520, a reflector 522, an antenna driver 524, a cover 526, and a support member 528.

The radiator 520 may absorb a satellite signal and convert the absorbed satellite signal into an electrical signal. The reflector 522 may block unwanted signals coming from the rear of the radiator. In addition, the reflector 522 may focus an incoming satellite signal onto the radiator 520.

According to an embodiment, the radiator 520 and the reflector 522 may have a directivity to receive satellite signals in a specific direction. The radiator 520 and the reflector 522 may be arranged to face a specific direction corresponding to a reception angle range. The radiator 520 may convert a satellite signal coming from a specific direction relative to a signal receiving surface into an electrical signal. The signal receiving surface may define a receiving direction of the directional antenna 232. The directional antenna 232 may provide high sensitivity and gain centered on the signal receiving surface. The signal receiving surface may be set to correspond to a reception angle range set for the corresponding repeater device 120.

The antenna driver 524 may support the radiator 520 and the reflector 522. In addition, the antenna driver 524 may move the radiator 520 and the reflector 522 to change the signal receiving surface. The antenna driver 524 may move the radiator 520 and the reflector 522 so that the radiator 520 and the reflector 522 face a direction corresponding to the reception angle range. The antenna driver 524 may adjust the signal receiving surface by rotating the radiator 520 and the reflector 522 around the vertical axis.

According to an embodiment, the antenna driver 524 may include a two-axis motor. The antenna driver 524 may control the signal receiving surfaces of the radiator 520 and reflector 522 by driving the two-axis motor.

The support member 528 may fix and support the antenna driver 524. The support member 528 may include a certain driving circuit. The driving circuit may include the processor 230, which is configured to control the repeater device 120, the GNSS receiver 234, the communication module 236, and a power module (not shown).

The cover 526 may cover the repeater device 120 and protect components of the repeater device 120. The cover 526 may correspond to, for example, a radome. The cover 526 may have a property of transmitting a satellite signal.

According to an embodiment, the directional output module 238 of the repeater device 120 may be coupled to the support member 528.

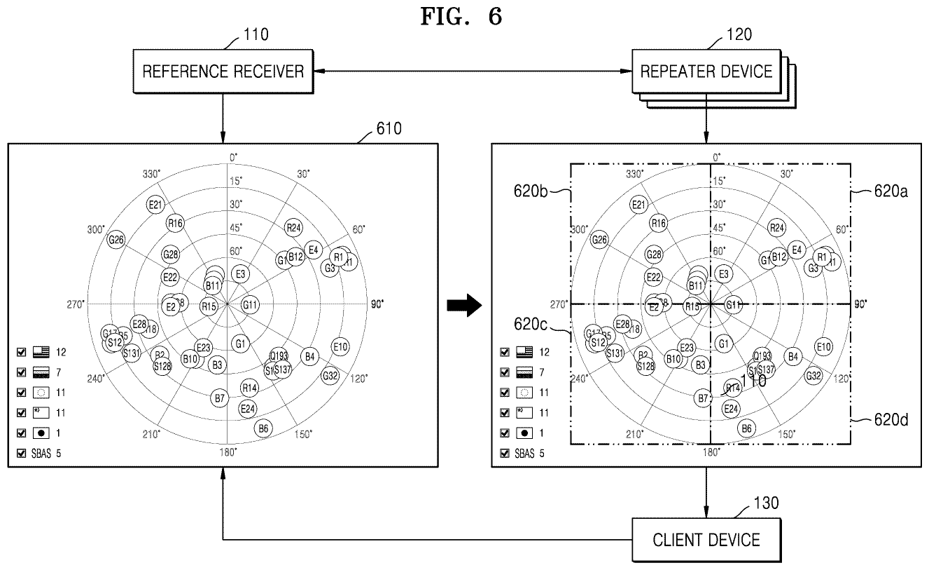

FIG. 6 is a diagram illustrating a reference satellite signal and a directional satellite signal according to an embodiment.

According to an embodiment, the reference receiver 110 may receive a reference satellite signal 610. Each repeater device 120 may receive directional satellite signals 620a, 620b, 620c, and 620d corresponding to a set reception angle range. According to an embodiment, the first repeater device 120a may receive the first directional satellite signal 620a in a reception angle range corresponding to the first quadrant of 0 degrees to 90 degrees. The second repeater device 120b may receive the second directional satellite signal 620b in a reception angle range corresponding to the second quadrant of 90 degrees to 180 degrees. The third repeater device 120c may receive the third directional satellite signal 620c in a reception angle range corresponding to the third quadrant of 180 degrees to 270 degrees. The fourth repeater device 120d may receive the fourth directional satellite signal 620d in a reception angle range corresponding to the fourth quadrants of 270 degrees to 360 degrees.

Referring to FIG. 6, the reference satellite signal 610 may receive satellite signals in a 360-degree angular range, i.e., in all directions. Because each satellite 140 outputs satellite signals while rotating around the Earth in real time, the satellite signals output from each satellite 140 are incident on the GNSS signal output apparatus 100 from a direction corresponding to a current position of the satellite 140. For example, a B12 satellite signal of FIG. 6 may be received at the reference receiver 110 at a reception angle corresponding to 62 degrees at a certain point in time. The reference receiver 110 may identify a reception angle of the received satellite signal. The reference receiver 110 may generate satellite reception angle information including reception angle information of satellite signals of each satellite included in the reference satellite signal.

According to an embodiment, each repeater device 120 may communicate with the reference receiver 110 and compare the reference satellite signal 610 with the directional satellite signals 620a, 620b, 620c, and 620d received from the repeater device 120. For example, the first repeater device 120a may compare satellite reception angle information corresponding to the reception angle range of the first repeater device 120a in the first directional satellite signal 620a and the reference satellite signal 610. The first repeater device 120a may adjust the reception angle range of the first repeater device 120a based on the result of the comparison. For example, when the reception angle of the B12 satellite signal in the reference satellite signal 610 is 0 to 90 degrees, and the reception angle of the B12 satellite signal in the first directional satellite signal 620a is 10 to 100 degrees, the first repeater device 120a may adjust a direction of the signal receiving surface of the directional antenna 232 so that the reception angle of the B12 satellite signal is 0 to 90 degrees.

According to an embodiment, the repeater device 120 may compare the directional satellite signals 620a, 620b, 620c, and 620d with the reference satellite signal based on satellite signals for the plurality of satellites 140 included in the directional satellite signals 620a, 620b, 620c, and 620d. For example, the first repeater device 120a may compare the reception angle of the reference satellite signal 610 with the reception angle of the first directional satellite signal 620a for satellites G3, E11, R1, E4, B12, and R24 included in the 0 to 90 degree range of the reference satellite signal 610.

According to an embodiment, the reference receiver 110 may divide the reference satellite signal 610 into reception angle ranges for each repeater device 120, thereby generating sub-reference satellite signal or sub-satellite reception angle information for each repeater device 120. For example, the reference receiver 110 may generate a first sub-reference satellite signal in the range of 0 to 90 degrees from the reference satellite signal 610. The first sub-reference satellite signal becomes the reference satellite signal for the first repeater device 120a. In addition, the reference receiver 110 may generate a second sub-reference satellite signal in the range of 90 to 180 degrees from the reference satellite signal 610. The second sub-reference satellite signal becomes the reference satellite signal for the second repeater device 120b. In addition, the reference receiver 110 may generate a third sub-reference satellite signal in the range of 180 to 270 degrees from the reference satellite signal 610. The third sub-reference satellite signal becomes the reference satellite signal for the third repeater device 120c. In addition, the reference receiver 110 may generate a fourth sub-reference satellite signal in the range of 270 to 360 degrees from the reference satellite signal 610. The fourth sub-reference satellite signal becomes the reference satellite signal for the fourth repeater device 120d.

According to an embodiment, the reference receiver 110 may transmit the reference satellite signals to the respective repeater devices 120. In addition, according to an embodiment, the reference satellite signal may be stored in a memory of the reference receiver 110, and each repeater device 120 may periodically request the reference satellite signal stored in the reference receiver 110 and periodically receive the requested reference satellite signal from the reference receiver 110.

The client device 130 may receive the directional satellite signals 620a, 620b, 620c, and 620d from the plurality of repeater devices 120. The client device 130 may obtain location information from the directional satellite signals 620a, 620b, 620c, and 620d received in real time.

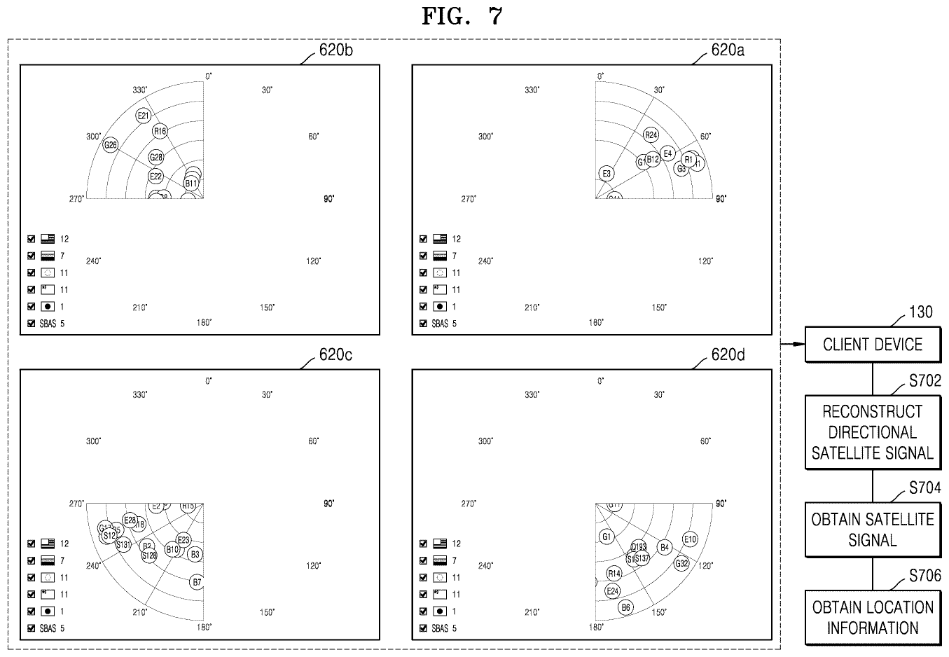

FIG. 7 is a diagram illustrating a process by which a client device obtains a satellite signal, according to an embodiment.

According to an embodiment, the client device 130 may receive the directional satellite signals 620a, 620b, 620c, and 620d and obtain satellite signals in a 360-degree range.

The client device 130 may receive the directional satellite signals 620a, 620b, 620c, and 620d at a certain location within the target area 440. In this case, each of the directional satellite signals 620a, 620b, 620c, and 620d is received by the client device 130 with a delay time reflecting the location of the client device 130. For example, it is assumed that the client device 130 is relatively close to the first repeater device 120a and relatively far from the third repeater device 120c. In this case, it is assumed that the first directional satellite signal 620a and the third directional satellite signal 620c are output from the first repeater device 120a and the third repeater device 120c at the same time. In this case, a time at which the client device 130 receives the third directional satellite signal 620c is later than a time at which the client device 130 receives the first directional satellite signal 620a. That is, the client device 130 receives the third directional satellite signal 620c with a longer delay time added to the third directional satellite signal 620c. This allows the client device 130 to obtain accurate location information within the target area 440 from the directional satellite signals 620a, 620b, 620c, and 620d.

Referring to FIG. 7, the client device 130 may reconstruct the plurality of directional satellite signals 620a, 620b, 620c, and 620d, in operation S702. The client device 130 may reconstruct a directional satellite signal by summing the plurality of directional satellite signals 620a, 620b, 620c, and 620d. In this case, the client device 130 may sum directional satellite signals 620a, 620b, 620c, and 620d received at the same time.

Next, in operation S704, the client device 130 may obtain an omnidirectional satellite signal from the reconstructed directional satellite signals 620a, 620b, 620c, and 620d. Because the obtained satellite signal is identical to the existing GNSS satellite signal, the client device 130 may receive and process the satellite signal by using the existing GNSS module.

Next, in operation S706, the client device 130 may obtain location information from the satellite signal. The client device 130 may obtain location information from the satellite signal by using the existing GNSS module and GNSS signal processing algorithm.

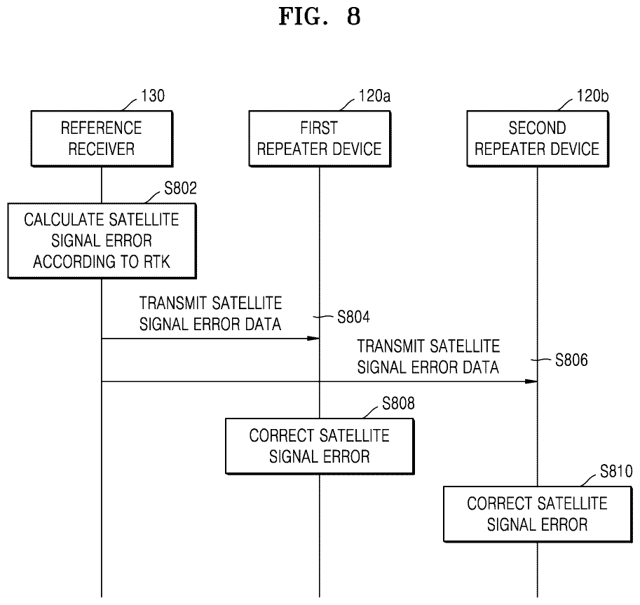

FIG. 8 is a flowchart of an operation in which a reference receiver serves as a real-time kinetic (RTK) base station, according to an embodiment.

According to an embodiment, the reference receiver 110 may serve as a base station for RTK. RTK is technology that provides high-precision location information by correcting, in real time, signals received from GNSS satellites. RTK may be primarily used in applications where centimeter-level accuracy is required. According to an embodiment, the reference receiver 110 may correspond to a base station of RTK, and the client device 130 may correspond to a rover station of RTK.

Referring to FIG. 8, the reference receiver 110 may calculate a satellite signal error according to RTK, in operation S802. The reference receiver 110 may receive the reference satellite signal and analyze an error of the reference satellite signal. The satellite signal error analysis of RTK may compare actual location information of the reference receiver 110 with location information calculated from the received reference satellite signal, and analyze the error based on a result of the comparison. The reference receiver 110 is installed at a certain location, and because the location of the reference receiver 110 is already known, the reference receiver 110 may calculate satellite signal error data by comparing the location information calculated from the reference satellite signal with the actual location information of the reference receiver 110.

Next, in operation S804, the reference receiver 110 may transmit the calculated satellite signal error data to the first repeater device 120a. In addition, in operation S806, the reference receiver 110 may transmit the calculated satellite signal error data to the second repeater device 120b.

The first repeater device 120a may correct a directional satellite signal received from the first repeater device 120a based on the satellite signal error data received from the reference receiver 110, in operation S808. In addition, the second repeater device 120b may correct a directional satellite signal received from the second repeater device 120b based on the satellite signal error data received from the reference receiver 110, in operation S810. Although only the operation of two repeater devices is shown in FIG. 8, the reference receiver 110 may transmit the satellite signal error data to all repeater devices 120 included in the GNSS signal output apparatus 100, and the repeater devices 120 may correct the satellite signal error based on the satellite signal error data.

The first repeater device 120a and the second repeater device 120b may correct the satellite signal error by combining the satellite signal error data received from the reference receiver 110 with the directional satellite signal. The satellite signal error data may include satellite orbit correction data, satellite clock correction data, ionospheric and tropospheric correction data, etc. The first repeater device 120a and the second repeater device 120b may correct the directional satellite signal by using satellite orbit error, satellite clock error, or atmospheric error included in the satellite signal error data. In addition, the first repeater device 120a and the second repeater device 120b may correct the directional satellite signal based on a precise location and time information of the satellite included in the satellite signal error data. In addition, the first repeater device 120a and the second repeater device 120b may utilize the satellite signal error data to remove signal delay caused by atmospheric refraction from the directional satellite signal.

The reference receiver 110 may generate satellite signal error data in real time by using a real-time reference satellite signal and transmit the satellite signal error data to the first repeater device 120a and the second repeater device 120b. The first repeater device 120a and the second repeater device 120b may correct a real-time directional satellite signal by using real-time satellite signal error data.

According to an embodiment, in the GNSS signal output apparatus 100, satellite signal correction is performed by RTK, thereby improving the accuracy of location information obtained by satellite signals.

In addition, according to an embodiment, the reference receiver 110 may transmit the satellite signal error data to the client device 130. The client device 130 may correct calculated location information by using the satellite signal error data.

Meanwhile, the disclosed embodiments may be implemented in the form of a computer-readable recording medium storing computer-executable instructions and data. The instructions described above may be stored in the form of program code, and when executed by a processor, may generate a certain program module and perform a certain operation. In addition, the instructions described above, when executed by the processor, may perform certain operations of the disclosed embodiments.

A device-readable storage medium may be provided in the form of a non-transitory storage medium. Here, the “non-transitory storage medium” indicates only that it is a tangible device and does not include signals (e.g. electromagnetic waves), and the term does not distinguish between cases where data is stored semi-permanently or temporarily on the storage medium. For example, the “non-transitory storage medium” may include a buffer in which data is temporarily stored.

According to an embodiment, the method according to various embodiments disclosed in the present document may be provided as included in a computer program product. The computer program product may be traded between sellers and buyers as commodities. The computer program product may be distributed in the form of a machine-readable storage medium (e.g., compact disc read only memory (CD-ROM)), or may be distributed online (e.g., by download or upload) via an application store or directly between two user devices (e.g., smartphones). In the case of online distribution, at least a portion of the computer program product (e.g., a downloadable application) may be temporarily stored or temporarily created in a device-readable storage medium, such as the memory of a manufacturer's server, an application store's server, or an intermediary server.

According to the embodiments, there is an effect of providing a GNSS signal output apparatus that enable a client device to receive a GNSS signal reflecting its own location in a GNSS shadow area, and a control method for the GNSS signal output apparatus.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A global navigation satellite system (GNSS) signal output apparatus comprising:
a reference receiver arranged within a GNSS shadow zone and configured to receive a reference satellite signal in a 360-degree range; and
a plurality of repeater devices arranged within the GNSS shadow zone, configured to receive a directional satellite signal with a reception angle in an angular range of less than 360 degrees, and configured to radiate the received directional satellite signal,
wherein the plurality of repeater devices are spaced apart from each other and have different ranges of reception angles, and a sum of reception angles of the plurality of repeater devices covers a range of 360 degrees, and
wherein each of the plurality of repeater devices is configured to adjust a range of the reception angle based on the reference satellite signal received by the reference receiver.

2. The GNSS signal output apparatus of claim 1, wherein a designated reception angle range is configured to be set within a 360-degree angle range for each of the plurality of repeater devices, and
wherein each of the plurality of repeater devices is configured to adjust the reception angle of a respective repeater device so that a satellite signal in the designated reception angle range of the respective repeater device in the reference satellite signal and a directional satellite signal received by the respective repeater device are matched.

3. The GNSS signal output apparatus of claim 1, wherein the plurality of repeater devices are radially arranged around the reference receiver, and
wherein each of the plurality of repeater devices has a reception angle corresponding to a direction in which a respective repeater device is arranged with respect to the reference receiver.

4. The GNSS signal output apparatus of claim 1, wherein the plurality of repeater devices include four repeater devices, and
wherein each of the plurality of repeater devices has a reception angle of 90 degrees.

5. The GNSS signal output apparatus of claim 1, wherein each of the plurality of repeater devices includes:
a directional antenna configured to receive a satellite signal with a limited reception angle; and
an antenna driver configured to change the reception angle of the directional antenna, and
wherein the antenna driver is further configured to control the directional antenna to receive the satellite signal with the reception angle set in a respective repeater device.

6. The GNSS signal output apparatus of claim 1, wherein the reference receiver and the plurality of repeater devices are configured to operate by receiving power via an Ethernet cable in a Power of Ethernet (PoE) manner.

7. The GNSS signal output apparatus of claim 1, wherein the reference receiver corresponds to a base station of Real-Time Kinematic (RTK) and is configured to calculate an error of the received satellite signal,
wherein the reference receiver is configured to transmit the calculated error of the satellite signal to each of the plurality of repeater devices, and
wherein the plurality of repeater devices are configured to correct the directional satellite signal based on the received error of the satellite signal and then radiate the directional satellite signal.

8. The GNSS signal output apparatus of claim 1, wherein a plurality of directional satellite signals radiated respectively from the plurality of repeater devices are received by a client device within the GNSS shadow zone, and
wherein the client device is configured to obtain a satellite signal by reconstructing the plurality of directional satellite signals.

9. The GNSS signal output apparatus of claim 1, wherein the GNSS shadow zone corresponds to a lower portion of an overpass, and
wherein the reference receiver and the plurality of repeater devices are installed in a structure in the lower portion of the overpass.

10. The GNSS signal output apparatus of claim 1, wherein each of the plurality of repeater devices includes a directional output module configured to radiate the directional satellite signal to a target area within the GNSS shadow zone.

11. The GNSS signal output apparatus of claim 10, wherein the plurality of repeater devices are arranged in a radial shape around the reference receiver, and
wherein the target area is an area including a center of the radial shape.

12. A control method for a global navigation satellite system (GNSS) signal output apparatus, wherein the GNSS signal output apparatus includes:
a reference receiver arranged within a GNSS shadow zone; and
a plurality of repeater devices arranged within the GNSS shadow zone,
wherein the plurality of repeater devices are spaced apart from each other and have different ranges of reception angles, and a sum of reception angles of the plurality of repeater devices covers a range of 360 degrees, and
wherein the control method for the GNSS signal output apparatus includes:
receiving, by the reference receiver, a reference satellite signal in a 360-degree range;
receiving, by each of the plurality of repeater devices, a directional satellite signal with a reception angle of an angular range of less than 360 degrees;
adjusting, by each of the plurality of repeater devices, a range of the reception angle based on the reference satellite signal received by the reference receiver; and
radiating, by each of the plurality of repeater devices, the received directional satellite signal.
